(19) United States
(12) Patent Application Publication
(10) Pub. No.: US 2016/0154235 A1
(43) Pub. Date: Jun. 2, 2016

(54) Anti-Fogging Mirror with Water Dispensing Outlet

(71) Applicant: Mark Wendell Stapleton, Tucson, AZ (US)

(72) Inventor: Mark Wendell Stapleton, Tucson, AZ (US)

(21) Appl. No.: 14/936,866

(22) Filed: Nov. 10, 2015

Related U.S. Application Data
(60) Provisional application No. 62/086,568, filed on Dec. 2, 2014.

(51) Int. Cl. G02B 27/00; A45D 42/08

(52) U.S. Cl. CPC G02B 27/0006; A45D 42/08

(57) ABSTRACT

An anti-fogging mirror with water dispensing outlet is an apparatus which allows for a water source to exchange heat to the mirror to prevent condensation as well as to exit at a velocity to efficiently clean grooming tools. The anti-fogging mirror with water dispensing outlet includes a mirror, a housing, a pipe, and a discharging nozzle. The mirror is mounted within the housing and allows for the user to view their reflection during a shower for grooming purposes. The pipe is vessel which connects to the water sources to transport a water stream through the housing to exchange thermal energy to the mirror as water passes through the pipe. Finally, the water is discharged from the apparatus through the discharging nozzle which increases the fluid velocity by decreasing the cross-sectional area in order to efficiently clean grooming tools.

The current application claims a priority to the U.S. Provisional Patent application Ser. No. 62/086,568 filed on Dec. 02, 2014.

### FIELD OF THE INVENTION

The present invention relates generally to an anti-fogging mirror with a water dispensing outlet. More specifically, the present invention relates to an anti-fogging mirror with a water dispensing outlet which exchanges heat between the water being dispensed to clean grooming tools and the mirror to preventing condensation from obscuring the reflection from the mirror.

### BACKGROUND OF THE INVENTION

Brushing teeth, shaving, and other facial treatments are commonly executed while in the shower for convenience. Performing these actions while in a shower saves time from cleaning a sink as the water washes away the shaved hair, waste from brushing teeth, and waste from the other facial treatments. Currently, shower mirrors are treated with an anti-fog coating minimizing the surface tension of water scattering water molecules across the surface instead of the droplets beading on the mirror surface; however, after repeated exposure to water, the anti-fog coating erodes. Once the anti-fog coating erodes, the mirror would fog up on subsequent uses in the shower. Users of these current shower mirrors are forced to use shower head discharge in order to clean razors, toothbrushes, and other beauty utensils. Depending on the water pressure, the water exiting the shower head may not be at sufficient velocity to clean these grooming tools.

The present invention is an anti-fogging mirror with a water dispensing outlet which provides the user with a mirror that will not be obscured through condensation while implemented which also dispenses water to clean grooming tools. The present invention is tied into the shower supply line in order to heat the mirror to the approximate temperature of the water exiting the shower head. Being the approximate temperature of the water, the mirror is less likely to have water vapor condense onto the surface of the mirror. The water flows through the present invention and out a nozzle, heating the mirror as it passes through the present invention. The nozzle increases the velocity of the water stream exiting the present invention to efficiently clean various grooming tools.

### BRIEF DESCRIPTION OF THE DRAWINGS

FIG. 1 is an isometric view of the present invention fully assembled.

FIG. 2 is an isometric exploded view of the present invention such that the interior of housing is visible.

FIG. 3 is a front view of the present invention.

FIG. 4 is a rear view of the present invention.

FIG. 5 is a cross-sectional view of the present invention along the line A-A of FIG. 3.

FIG. 6 is a side view of the present invention.

FIG. 7 is a bottom view of the present invention.

FIG. 8 is a front view of an alternate embodiment of the present invention, wherein the valve is adjacent to the outlet.

### DETAIL DESCRIPTIONS OF THE INVENTION

All illustrations of the drawings are for the purpose of describing selected versions of the present invention and are not intended to limit the scope of the present invention.

The present invention is for an anti-fogging mirror with water dispensing outlet. The present invention allows for a mirrored surface to be heated through use of shower piping or external hot water sources. Heating the mirror surface prevents water vapor from condensing on the mirror surface. Therefore, preventing the mirrored surface from being obscured from water condensate. Further, the present invention allows for the cleaning of grooming tools, such as toothbrushes, shaving razors, or other such beauty utensils, as water is discharged from the present invention. Thus, promoting efficient grooming whilst in the shower through an unobscured reflection from the mirror and the ability to clean grooming utensils.

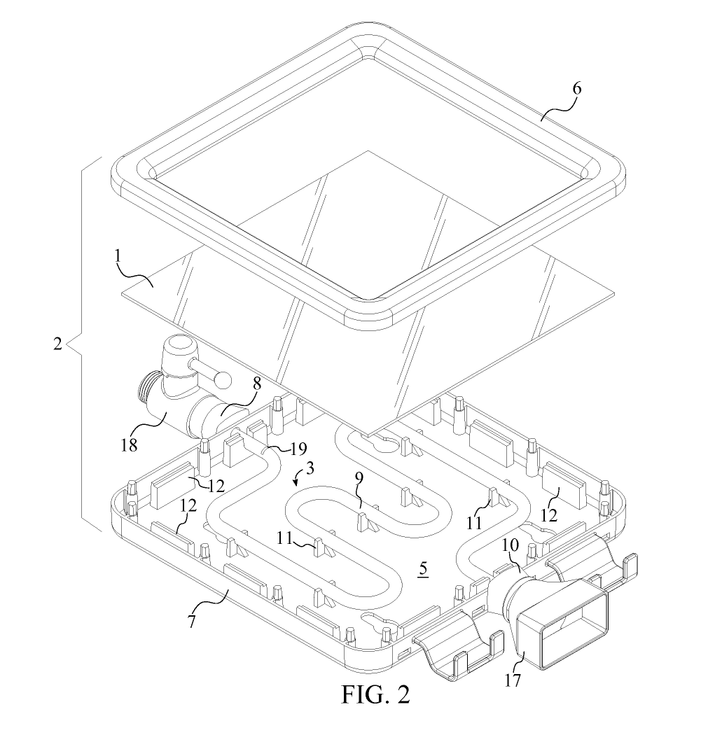

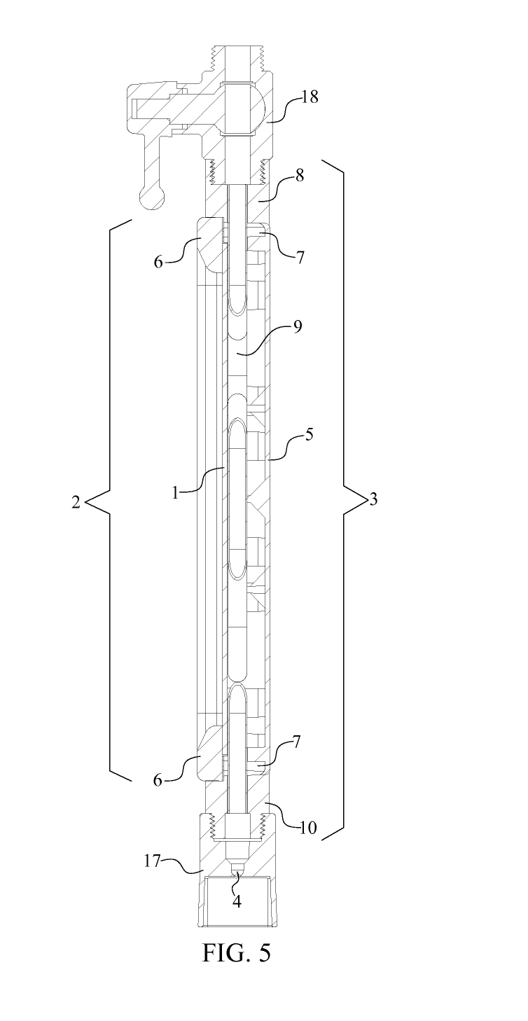

In accordance to FIG. 5, the present invention comprises a mirror 1, a housing 2, a pipe 3, and a discharging nozzle 4. The mirror 1 allows the user to view a reflection such that the user is able to groom the user's face. The housing 2 allows for the mirror 1 to be suspended onto a vertical support such that the mirror 1 is able to be positioned at the height of the user's head for optimal viewing of the user's reflection. The pipe 3 allows for water to flow through the present invention and heat transfer from the water to the mirror 1. The pipe 3 is preferred to be in fluid communication with the shower feed stream such that the shower feed stream is diverted to both the present invention and the shower head. The discharging nozzle 4 increases the velocity of the water stream exiting the present invention by decreasing the cross-sectional area significantly in order to provide sufficient fluid velocity to clean grooming tools efficiently. As shown in FIG. 2 and FIG. 5, the housing 2 comprises a rear panel 5, a front framing 6, and a lateral portion 7, which delineate an interior cavity for the internal components and the mirror 1 to be mounted within. The lateral portion 7 is perimetrically connected to the rear panel. The pipe 3 comprises an inlet 8, an intermediate portion 9, and an outlet 10, in accordance to FIG. 2 and FIG. 5. The inlet 8 is in fluid communication with the shower feed stream such that water is able to flow to the present invention. The inlet 8 and the outlet 10 are in fluid communication to each other through the intermediate portion 9. The intermediate portion 9 is mounted adjacent and parallel to the rear panel 5 within the housing 2. The mirror 1 is adjacently positioned to the intermediate portion 9, opposite the rear panel 5. The discharging nozzle 4 is in fluid communication with the outlet 10. This configuration allows for water from the shower stream feed to be transported through the present invention from the inlet 8, through the intermediate portion 9, into the outlet 10 and finally exiting the discharging nozzle 4. In accordance to the preferred embodiment, the inlet 8 traverses into the lateral portion 7, opposite to the outlet 10, wherein the outlet 10 traverses out from the lateral portion 7. This configuration is preferred since this configuration allows the present invention to be mounted flush onto a vertical support.

In order to secure the mirror onto the housing, the front framing 6 is positioned adjacent to the mirror 1 opposite the intermediate portion 9, such that the minor 1 is outlined by the front framing 6, and the front framing 6 engages the rear panel 5. The mirror 1 is mounted against the rear panel 5 by the front framing 6. In the preferred embodiment, the present invention comprises a plurality of mirror supports 12. The plurality of mirror supports 12 is mounted to the rear panel 5 between the rear panel 5 and the mirror 1. The mirror 1 is perimetrically mounted to the plurality of mirror supports 12. The plurality of mirror supports 12, along with the intermediate portion 9, prevents deformation to the mirror 1 as external pressure is applied. The front framing 6 is sealably pressed against the mirror 1. The front framing 6 is sealably and perimetrically mounted to the lateral portion 7. The front framing 6 is sealed to both the mirror 1 and the lateral portion 7 such that an interior cavity of the housing 2 is waterproof such that water condensate and water vapor does not permeate through the present invention into the interior cavity, reducing the propagation of mold and mildew within the present invention through use.

In accordance to the preferred embodiment, the present invention comprises a pipe aperture 19, as shown in FIG. 2. The pipe aperture 19 allows water to be sprayed onto the mirror 1 as the primary means of heat transfer. The pipe aperture 19 traverses into the intermediate portion 9 and is oriented toward the mirror 1 such that as the intermediate portion 9 is pressurized with water, water is forced through the pipe aperture 19 onto the mirror 1. The pipe aperture 19 is positioned offset from the inlet 8 in order to outlet water near the inlet 8 such that the water travels down the mirror 1 and out from the outlet 10 as the present invention is mounted onto a vertical support. As the water is in contact with the mirror 1, heat is conducted from the water to the mirror 1 in order to increase the surface temperature of the mirror 1 in order to reduce condensation on the mirror 1. This configuration still allows for water to directly transfer heat to the mirror 1 as well as being dispensed from the discharging nozzle 4 with sufficient velocity to clean grooming tools.

In some embodiments, the present invention comprises a heat dispersion plate. The heat dispersion plate allow for the even dissipation of heat from the hot water source through the intermediate portion 9 to the mirror 1. The heat dispersion plate is mounted to the rear panel 5, between the mirror 1 and the rear panel 5. The heat dispersion plate is positioned between the intermediate portion 9 and the mirror 1. The heat dispersion plate is preferred to be copper due to copper's thermal properties; however, the heat dispersion plate may be made from any material which has a similar thermal conductivity. As hot water travels through the intermediate portion 9, the heat dissipation plate is heated through conduction from the intermediate portion 9. The mirror 1 is subsequently heated through conduction from the heat dissipation plate.

When pipes are charged with water or valves are toggled to allow flow of water, the velocity of the water may sometimes create vibrations within a piped system. If the pipe 3 were to vibrate violently, there exists the possibility of the mirror 1 breaking. In order to prevent this from happening, the present invention comprises a plurality of pipe supports 11 to counter the effects from the water pressure through the pipe 3. The plurality of pipe supports 11 is mounted to the rear panel 5 between the rear panel 5 and the mirror 1. The intermediate portion 9 is mounted to the plurality of pipe supports 11 in order to secure the intermediate portion 9 to the housing 2 while dampening the vibrations of the pipe 3 when the pipe 3 would otherwise vibrate due to the water pressure through the pipe 3.

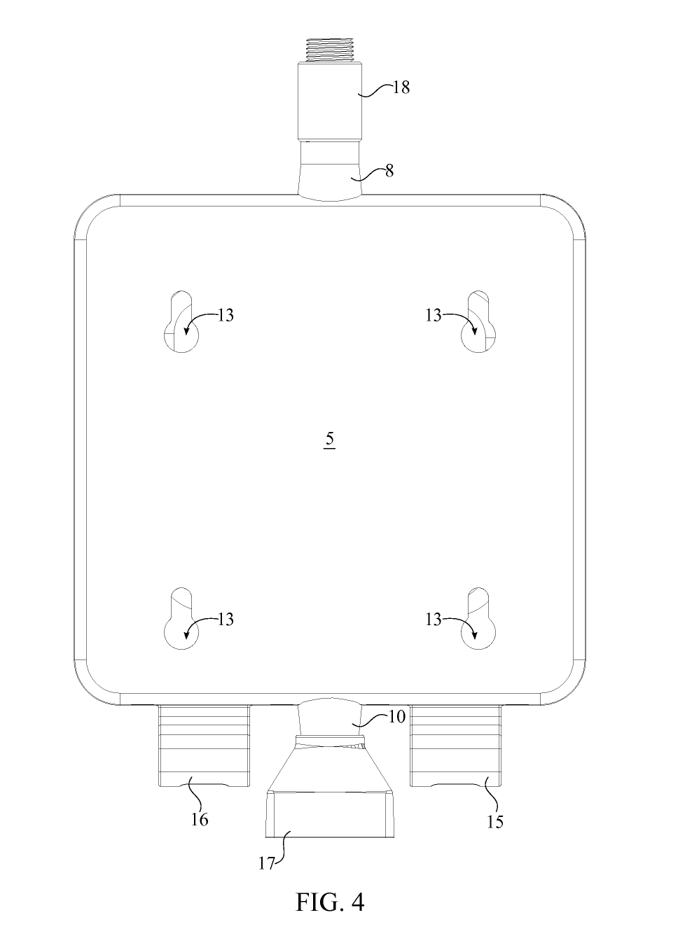

In order to secure the present invention onto a vertical support, the present invention comprises a plurality of shower wall mounts 13, detailed in FIG. 4. The plurality of shower wall mounts 13 is evenly distributed across and integrated into the rear panel 5 such that the present invention is securely attaches to the vertical support. In accordance to the preferred embodiment, the plurality of shower wall mounts 13 comprises a plurality of mounting orifices and a plurality of suction cups. The plurality of mounting orifices traverses through the rear panel 5. Each of the plurality of suction cups engages each of the plurality of mounting orifices such that the present invention is mounted to the vertical support through the plurality of suction cups.

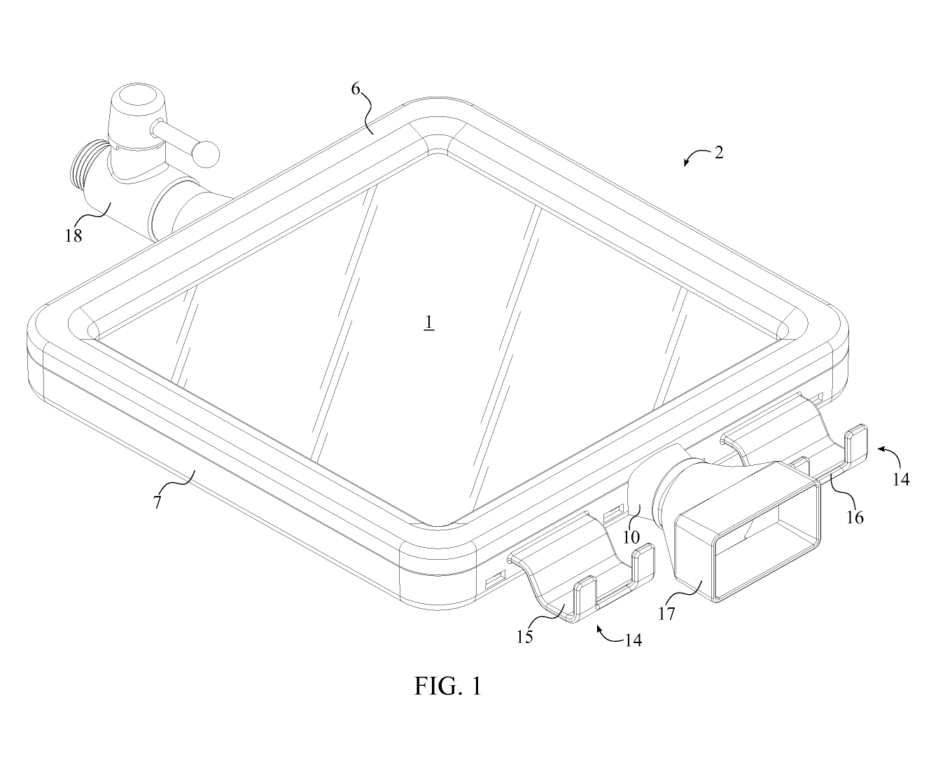

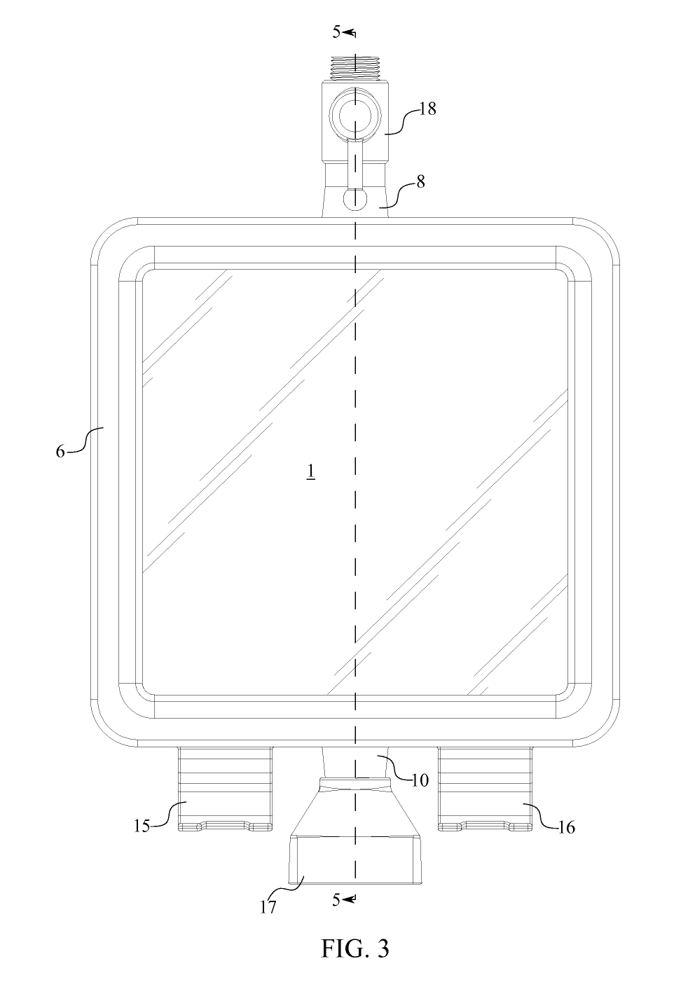

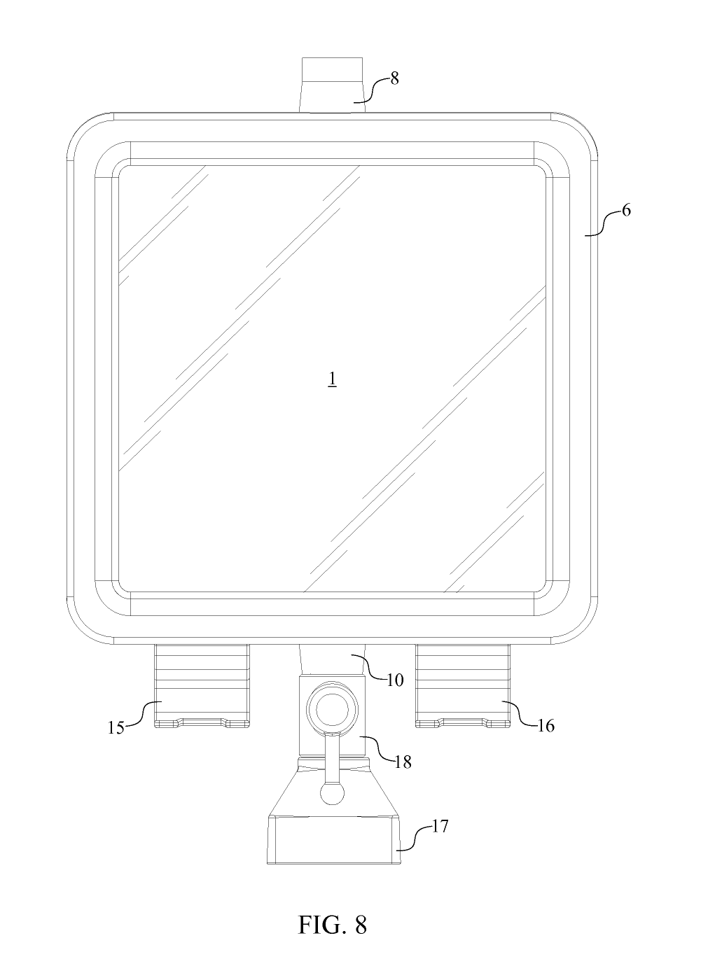

As previously mentioned, the present invention allows for grooming in the shower to be more efficient. To assist in facilitating this function, the present invention includes at least one razor rack 14, as shown in FIG. 1. The at least one razor rack 14 allows for shaving razors to be stored onto the present invention between uses. The at least one razor rack 14 is externally connected to the lateral portion 7. In accordance to the preferred embodiment and FIG. 1, FIG. 3, FIG. 4 and FIG. 8, the at least one razor rack 14 comprises a first razor rack 15 and a second razor rack 16. The first razor rack 15 is positioned adjacent to the outlet 10. Similarly, the second razor rack 16 is positioned adjacent to the outlet 10, opposite to the first razor rack 15. Thus, allowing two shaving razors to be stored on the present invention by the razor head in between uses.

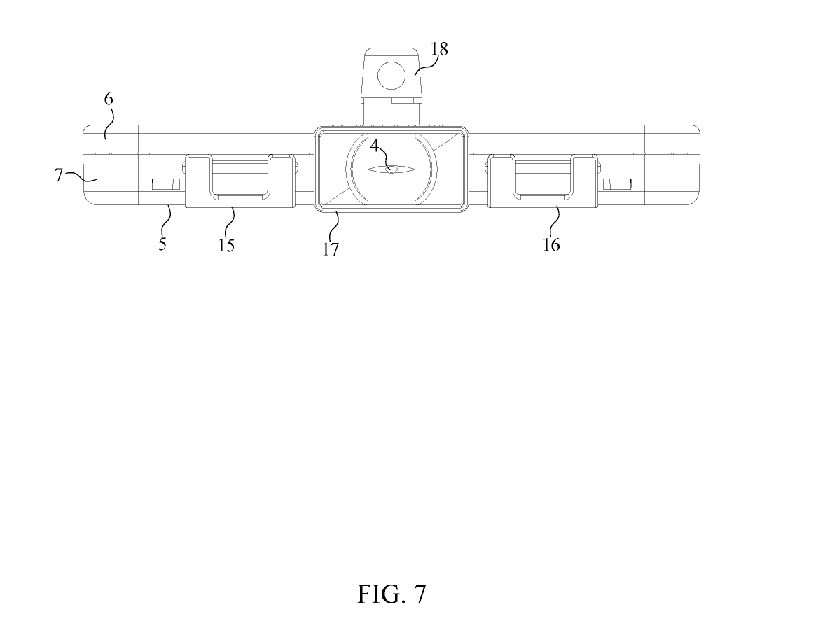

In accordance to the preferred embodiment and FIG. 7, the discharging nozzle 4 is preferred to be a fan nozzle such that the water stream covers a large lateral area while providing sufficient pressure to clean grooming utensils. However, the discharge spread of water from the present invention may fan out too far from the present invention. Therefore, the preferred embodiment of the present invention further comprises a guidance skirt 17. The guidance skirt 17 limits the angle of the discharging water stream. The guidance skirt 17 is externally positioned to the housing 2 and connected around the discharging nozzle 4 in a manner which limits the angle of the discharge stream.

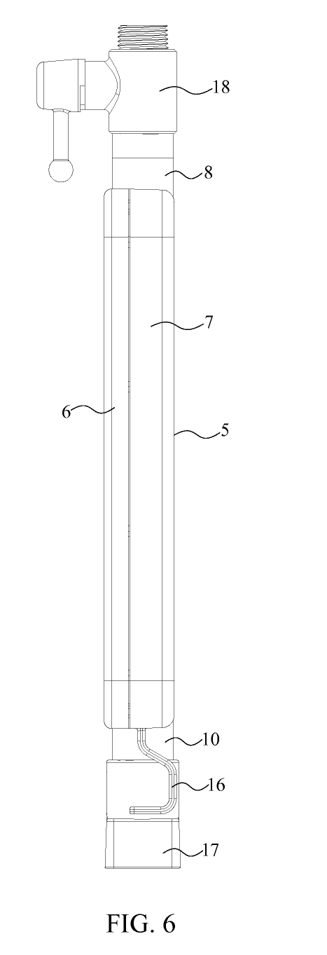

In order to control the discharge stream, the present invention comprises a valve 18 which is in fluid communication with the pipe 3. The valve 18 allows the user to control water flow through the present invention. The valve 18 is preferred to be a ball valve 18; however, the valve 18 includes, but is not limited to, a gate valve, butterfly valve, or any other similar valve appropriate within the spirit of the present invention. In some embodiments of the present invention, the valve 18 is in fluid communication with the inlet 8, as shown in FIG. 2 and FIG. 3 to FIG. 6. Thus, eliminating pressure within the present invention while the present invention is not in use. In alternate embodiments detailed in FIG. 8, the valve 18 is in fluid communication with the outlet 10 such that the valve 18 is positioned between the intermediate portion 9 and the outlet 10. This configuration allows for a quicker initial discharge, as the water stream does not have to travel through the entire pipe 3. As the intermediate portion 9 is filled after the first use, this configuration would reduce vibrations from the pressure due to water stream filling the intermediate portion 9.

Although the invention has been explained in relation to its preferred embodiment, it is to be understood that many other possible modifications and variations can be made without departing from the spirit and scope of the invention as hereinafter claimed.

What is claimed is:

1. An anti-fogging mirror with water dispensing outlet comprise:
a mirror;
a housing;
a pipe;
a discharging nozzle;
the housing comprises a rear panel, a front framing and a lateral portion;
the pipe comprises an inlet, an intermediate portion, and an outlet;
the lateral portion being perimetrically connected to the rear panel;
the intermediate portion being mounted adjacent and parallel to the rear panel within the housing;
the inlet traversing into the housing;
the outlet traversing out of the lateral portion;
the inlet and the outlet being in fluid communication with each other through the intermediate portion;
the mirror being adjacently positioned to the intermediate portion, opposite the rear panel;
the front framing being positioned adjacent to the mirror, opposite to the intermediate portion;
the mirror being mounted against the rear panel by the front framing;
the front framing being sealably pressed against the mirror;
the front framing being sealably and perimetrically mounted to the lateral portion; and
the discharging nozzle being in fluid communication with the outlet.

2. The anti-fogging mirror with water dispensing outlet as claimed in claim 1 comprises:
the inlet traversing into the lateral portion opposite to the outlet.

3. The anti-fogging mirror with water dispensing outlet as claimed in claim 1 comprises:
a pipe aperture;
the pipe aperture traversing into the intermediate portion; and
the pipe aperture being positioned offset from the inlet.

4. The anti-fogging mirror with water dispensing outlet as claimed in claim 3 comprises:
the pipe aperture being oriented toward the mirror.

5. The anti-fogging mirror with water dispensing outlet as claimed in claim 1 comprises:
a plurality of pipe supports;
the plurality of pipe supports being mounted to the rear panel between the rear panel and the mirror; and
the intermediate portion being mounted to the plurality of pipe supports.

6. The anti-fogging mirror with water dispensing outlet as claimed in claim 1 comprises:
a plurality of mirror supports;
the plurality of mirror supports being mounted to the rear panel between the rear panel and the mirror; and
the mirror being perimetrically mounted to the plurality of mirror supports.

7. The anti-fogging mirror with water dispensing outlet as claimed in claim 1 comprises:
a plurality of shower wall mounts;
the plurality of shower wall mounts being evenly distributed across the rear panel; and
the plurality of shower wall mounts being integrated into the rear panel.

8. The anti-fogging mirror with water dispensing outlet as claimed in claim 1 comprises:
at least one razor rack; and
the at least one razor rack being externally connected to the lateral potion.

9. The anti-fogging mirror with water dispensing outlet as claimed in claim 8 comprises:
the at least one razor rack being a first razor rack and a second razor rack;
the first razor rack being positioned adjacent to the outlet; and
the second razor rack being positioned adjacent to the outlet, opposite to the first razor rack.

10. The anti-fogging mirror with water dispensing outlet as claimed in claim 1 comprises:
a guidance skirt;
the guidance skirt being externally positioned to the housing; and
the guidance skirt being connected around the discharging nozzle.

11. The anti-fogging mirror with water dispensing outlet as claimed in claim 1 comprises:
a valve; and
the valve being in fluid communication with the pipe.

12. The anti-fogging mirror with water dispensing outlet as claimed in claim 11 comprises:
the valve being in fluid communication with the inlet.

13. The anti-fogging mirror with water dispensing outlet as claimed in claim 11 comprises:
the valve being in fluid communication with the outlet.
